(19) United States
(12) Patent Application Publication
(10) Pub. No.: US 2026/0074450 A1
(43) Pub. Date: Mar. 12, 2026

(54) CONTACT, CONNECTOR AND CONTACT MOUNTING BOARD

(71) Applicant: JAPAN AVIATION ELECTRONICS INDUSTRY, LIMITED, Tokyo (JP)

(72) Inventor: Kenta ASHIBU, Tokyo (JP)

(73) Assignee: JAPAN AVIATION ELECTRONICS INDUSTRY, LIMITED, Tokyo (JP)

(21) Appl. No.: 19/303,014

(22) Filed: Aug. 18, 2025

(30) Foreign Application Priority Data
Sep. 6, 2024 (JP) 2024-154182

(51) Int. Cl. H01R 12/71

(52) U.S. Cl. CPC H01R 12/714

(57) ABSTRACT

A contact has a mounting portion, a resilient deformation portion with a cantilever shape and an expansion portion. The resilient deformation portion is provided with a first contact portion and a second contact portion located between the first contact portion and the mounting portion. The expansion portion is provided with a third contact portion. Resilient deformation of the resilient deformation portion allows the second contact portion to be brought into contact with the third contact portion. In a state where the second contact portion is brought into contact with the third contact portion, a first current path from the first contact portion to the mounting portion via the resilient deformation portion is shorter than a second current path from the first contact portion to the mounting portion via the third contact portion.

### CROSS REFERENCE TO RELATED APPLICATIONS

This application is based on and claims priority under 35 U.S.C. § 119 to Japanese Patent Application No. JP2024-154182 filed Sep. 6, 2024, the contents of which are incorporated herein in their entirety by reference.

### BACKGROUND OF THE INVENTION

This invention relates to a contact. This invention also relates to a connector provided with the contact and to a contact mounting board provided with the contact.

JP 2023-75527A (Patent Document 1) discloses an electric connector provided with a contact.

Referring to FIGS. 19 and 20, a contact 90 included in an electric connector disclosed in Patent Document 1 is provided with a resilient deformation portion 92. The resilient deformation portion 92 has a first contact portion 921 and a second contact portion 923.

As understood from FIGS. 19 and 20, when a connection object (not shown) is brought into contact with the first contact portion 921 from above and presses the first contact portion 921 downward, the resilient deformation portion 92 is resiliently deformed. Consequently, the second contact portion 923 is moved downward and brought into contact with a third contact portion 94. In a contact state where the second contact portion 923 is brought into contact with the third contact portion 94, two current paths from the first contact portion 921 to a soldering portion 96 are formed in the contact 90. One of the current paths is a first current path from the first contact portion 921 to the soldering portion 96 via a curved portion 925. The remaining one of the current paths is a second current path from the first contact portion 921 to the soldering portion 96 via the second contact portion 923 and the third contact portion 94. Besides, the length of the second current path is shorter than that of the first current path.

As understood from the above description, the contact 90 of Patent Document 1 achieves a soft spring by lengthening the length of the resilient deformation portion 92 and shortening the current path from the first contact portion 921 to the soldering portion 96 by providing the second contact portion 923 on the resilient deformation portion 92.

### SUMMARY OF THE INVENTION

In the contact 90 of Patent Document 1, the resilient deformation portion 92 is formed as a cantilever and acts as a soft spring. However, when the second contact portion 923 is brought into contact with the third contact portion 94, the resilient deformation portion 92 acts as a both ends supported spring, and its spring characteristics are remarkably deteriorated. Accordingly, the contact 90 of Patent Document 1 has a disadvantage that it is easy to be plastically deformed or damaged when the resilient deformation portion 92 is resiliently deformed.

It is therefore an object of the present invention to provide a contact which is provided with a resilient deformation portion with a cantilever shape and which can suppress deterioration of spring characteristics and shorten a current path when resilient deformation portion is resiliently deformed. Also, it is another object of the present invention to provide a connector provided with such a contact and a contact mounting board provided with such a contact.

One aspect of the present invention provides a contact which electrically connects a first connected portion of a first board located downward of the contact in an up-down direction to a second connected portion of a second board located upward of the contact in the up-down direction. The contact has a mounting portion connected to the first connected portion, a resilient deformation portion extending from the mounting portion and having a cantilever shape and an expansion portion extending from the mounting portion. The resilient deformation portion is provided with a first contact portion to be brought into contact with the second connected portion and a second contact portion located between the first contact portion and the mounting portion in the up-down direction. The expansion portion is provided with a third contact portion. When the first contact portion is brought into contact with the second connected portion while the resilient deformation portion is resiliently deformed, the second contact portion and the third contact portion are brought into contact with each other in a lateral direction perpendicular to the up-down direction. In a contact state where the second contact portion and the third contact portion are bought into contact with each other, a length of a second current path from the first contact portion to the mounting portion via the second contact portion and the third contact portion is shorter than a length of a first current path from the first contact portion to the mounting portion via the resilient deformation portion.

Another aspect of the present invention provides a connector which comprises the aforementioned contact and a holding member holding the contact.

Yet another aspect of the present invention provides a contact mounting board which comprises a plurality of the aforementioned contacts and a board. The contacts are arranged on the board.

In the contact of the above-mentioned aspect of the present invention, the second contact portion provided on the resilient deformation portion and the third contact portion provided on the expansion portion are brought into contact with each other in a lateral direction when the resilient deformation portion is resiliently deformed. Thus, suppressing deterioration of spring characteristics of the resilient deformation portion and shortening a current path of the contact can be achieved when the resilient deformation portion is resiliently deformed.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a contact according to an embodiment of the present invention. The contact is in an initial state.

FIG. 2 is a side view showing the contact of FIG. 1, a first board provided with a first connected portion and a second board provided with a second connected portion.

FIG. 3 is a plan view showing the contact of FIG. 1.

FIG. 4 is a cross-sectional view showing the contact of FIG. 3, taken along A-A line.

FIG. 5 is a bottom view showing the contact of FIG. 1.

FIG. 6 is a front view showing the contact of FIG. 1.

FIG. 7 is a rear view showing the contact of FIG. 1.

FIG. 8 is a perspective view showing the contact of FIG. 1. The contact is in a contact state.

FIG. 9 is a side view showing the contact of FIG. 8.

FIG. 10 is a plan view showing the contact of FIG. 8.

FIG. 11 is a cross-sectional view showing the contact of FIG. 10, taken along B-B line.

FIG. 12 is a bottom view showing the contact of FIG. 8.

FIG. 13 is a front view showing the contact of FIG. 8.

FIG. 14 is a rear view showing the contact of FIG. 8.

FIG. 15 is a perspective view showing a contact mounting board provided with a plurality of contacts of FIG. 1.

FIG. 16 is a plan view showing a connector provided with a plurality of contacts of FIG. 1 and a holding member holding the contacts.

FIG. 17 is a front view showing the connector of FIG. 15.

FIG. 18 is a bottom view showing the connector of FIG. 15.

FIG. 19 is a perspective view showing a contact disclosed in Patent Document 1.

FIG. 20 is a partial, cross-sectional view showing an electric connector provided with the contact of FIG. 19.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

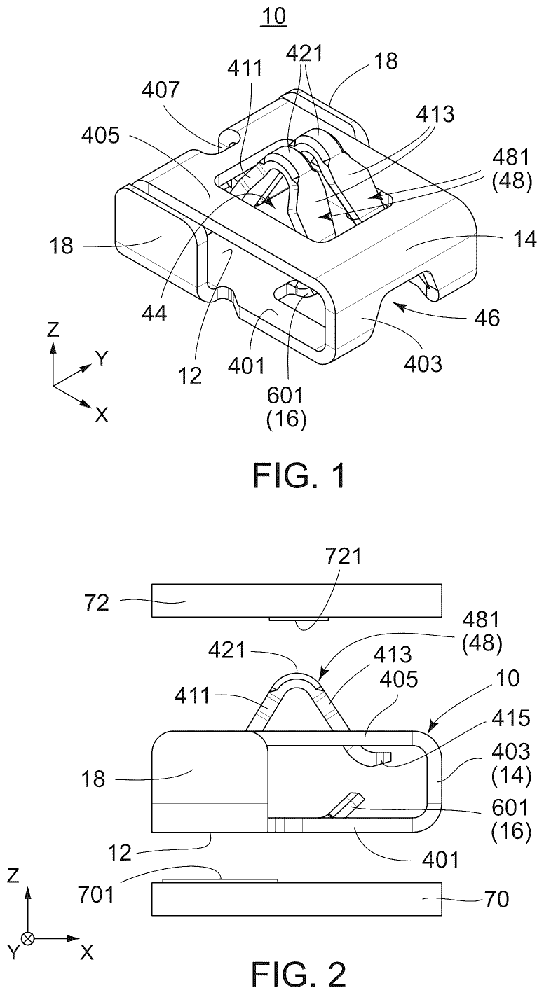

Referring to FIG. 1, a contact 10 according to an embodiment of the present invention has a generally rectangular parallelepiped shape in which a size is relatively small in an up-down direction. At an upper middle of the contact 10, an upper aperture 44 is provided. A free end portion 48 of a resilient deformation portion 14 mentioned later protrudes upward in part through the upper aperture 44. In the present embodiment, the up-down direction is a Z-direction. A positive Z-direction is directed upward while a negative Z-direction is directed downward.

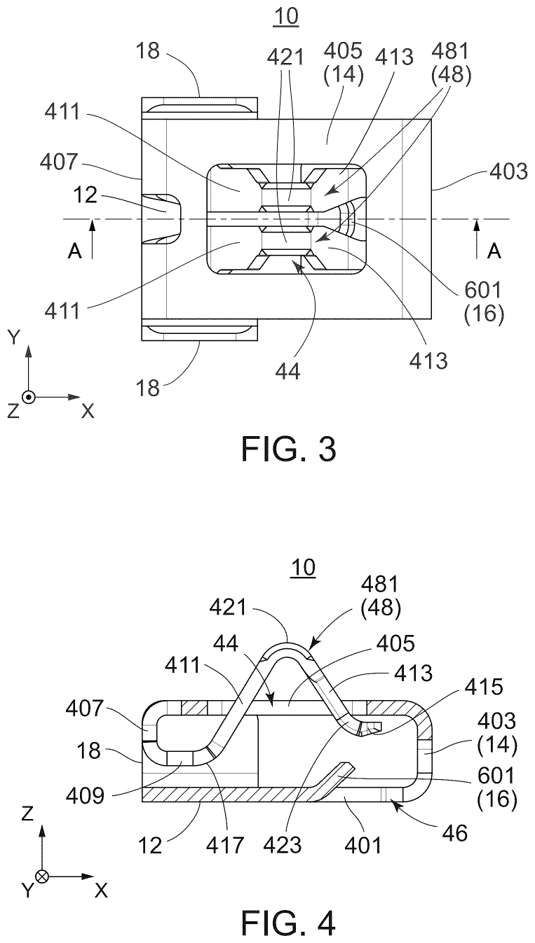

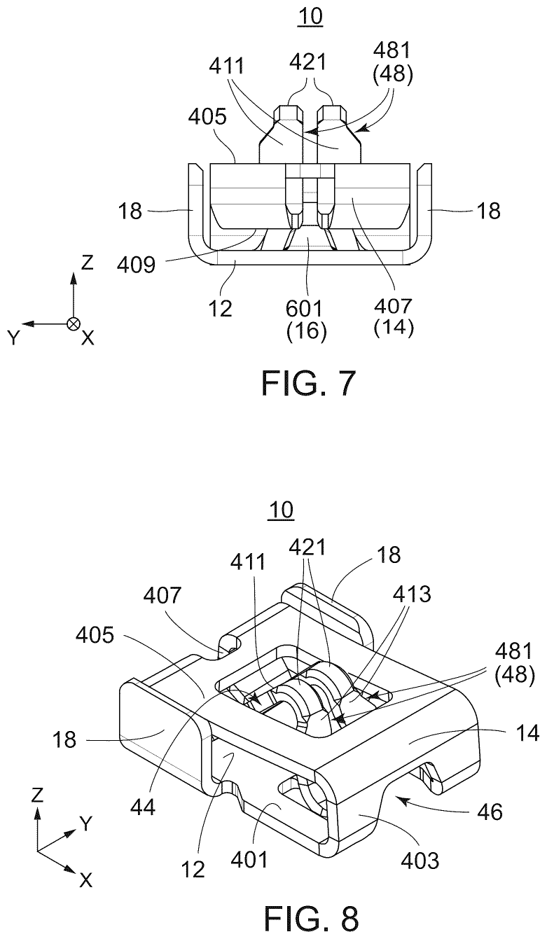

As understood from FIGS. 3 and 5 to 7, the contact 10 has a symmetrical shape with respect to a plane or a symmetrical plane which is parallel to the up-down direction and passes across a middle of the contact 10 in a lateral direction perpendicular to the up-down direction. In the present embodiment, the lateral direction is a Y-direction. However, the present invention is not limited thereto. The present invention can be implemented with a half of the contact 10 divided by the symmetrical plane in two, and the present invention may not have a symmetrical shape.

Referring to FIG. 2, the contact 10 is a contact which electrically connects a first connected portion 701 of a first board 70 to a second connected portion 721 of a second board 72. The first connected portion 701 is located upward of the second connected portion 721 in the up-down direction. The first connected portion 701 is a connection pad formed on an upper surface of the first board 70, for example. The second connected portion 721 is a contact pad, a terminal or a contact point which is formed on a lower surface of the second board 72, for example. The contact 10 is mounted on the first board 70 and fixed and connected to the first connected portion 701, for example. Moreover, the contact 10 is put closer to the second board 72 and brought into contact with and connected to the second connected portion 721.

Referring to FIGS. 3 and 4, the contact 10 has a mounting portion 12, the resilient deformation portion 14 and an expansion portion 16. The contact 10 may be formed by cutting and bending a sheet metal, for example.

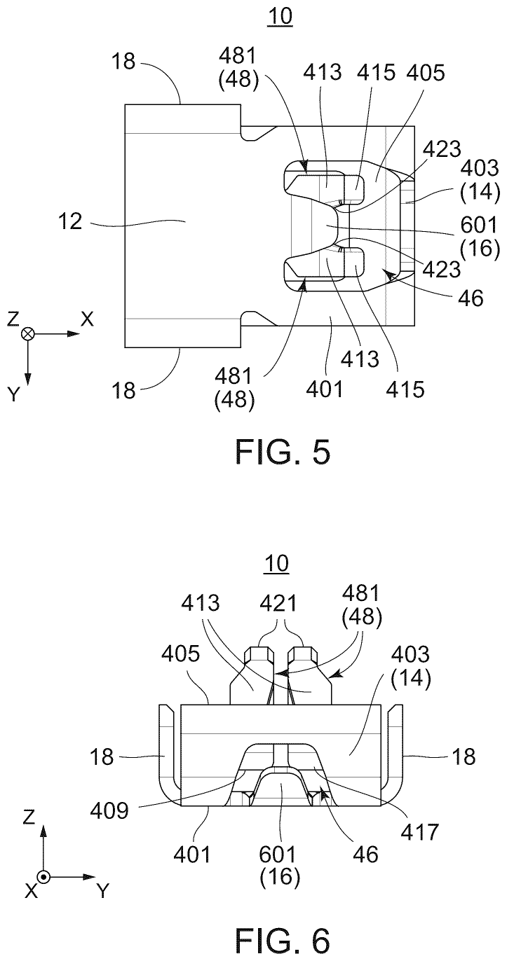

As understood from FIGS. 4 and 5, the mounting portion 12 is located rearward of the lowest portion of the contact 10. When viewed along the up-down direction, the mounting portion 12 has a generally rectangular shape long in the lateral direction and occupies about one-third of a bottom surface of the contact 10. As understood from FIG. 2, the mounting portion 12 is connected to the first connected portion 701 when used.

As shown in FIGS. 4 and 5, both the resilient deformation portion 14 and the expansion portion 16 extend from the mounting portion 12. In the present embodiment, the resilient deformation portion 14 extends forward from the mounting portion 12. Moreover, in the present embodiment, the expansion portion 16 extends forward from the mounting portion 12 and then extends forward-diagonally upward. In the present embodiment, a front-rear direction is a direction perpendicular to both the up-down direction and the lateral direction, i.e., an X-direction. A positive X-direction is directed forward while a negative X-direction is directed rearward.

As shown in FIGS. 5 and 6, the resilient deformation portion 14 is formed with a lower aperture 46. When viewed from beneath along the up-down direction, the expansion portion 16 is located in the lower aperture 46 in part. In the present embodiment, the resilient deformation portion 14 and the expansion portion 16 have a base portion in common with each other. In other words, in the present embodiment, a third contact portion 601 of the expansion portion 16, which is described later, is branched from the resilient deformation portion 14. However, the present invention is not limited thereto. In the present invention, the resilient deformation portion 14 and the expansion portion 16 may be completely separated from each other.

As understood from FIG. 4, the resilient deformation portion 14 is formed as a cantilever. In detail, the resilient deformation portion 14 has a first horizontal portion 401, a first vertical portion 403, a second horizontal portion 405, a second vertical portion 407, a third horizontal portion 409, a first inclined portion 411, a second inclined portion 413 and a fourth horizontal portion 415. Note that, the terms “horizontal portion” and “vertical portion” are expediently used in the present description, they do not necessarily mean that they are perpendicular to or parallel with the up-down direction. In other words, the “horizontal portion” may be inclined with respect to a direction perpendicular to the up-down direction, and the “horizontal portion”may be inclined with respect to the up-down direction.

As shown in FIG. 4, the first horizontal portion 401 extends forward from a front edge of the mounting portion 12. The first vertical portion 403 extends upward from a front edge of the first horizontal portion 401. The second horizontal portion 405 extends rearward from an upper edge of the first vertical portion 403. The second vertical portion 407 extends downward from a rear edge of the second horizontal portion 405. The third horizontal portion 409 extends forward from a lower edge of the second vertical portion 407. The first inclined portion 411 extends frontward-diagonally upward from a front edge of the third horizontal portion 409. The second inclined portion 413 extends frontward-diagonally downward from a front edge of the first inclined portion 411. The fourth horizontal portion 415 extends forward from a front edge of the second inclined portion 413.

As shown in FIG. 4, the third horizontal portion 409 is located upward of and apart from the mounting portion 12. Each of the first inclined portion 411 and the second inclined portion 413 is located upward of the second horizontal portion 405 in part in the up-down direction. For achieving this structure, the second horizontal portion 405 is provided with the upper aperture 44 mentioned above.

As understood from FIGS. 3, 4 and 7, the free end portion 48 of the resilient deformation portion 14 branches off into two branch portions 481. In the present embodiment, the free end portion 48 of the resilient deformation portion 14 refers to the portion from near a rear end of the second horizontal portion 405 to a front end of the fourth horizontal portion 415.

As understood from FIGS. 2 to 4, in each of the branch portions 481, a border part between the first inclined portion 411 and the second inclined portion 413 forms a first contact portion 421. Thus, the resilient deformation portion 14 is provided with the first contact portion 421 which is brought into contact with the second connected portion 721. In the present embodiment, the first contact portion 421 is located between the mounting portion 12 and a second contact portion 423 mentioned later in the front-rear direction. However, the present invention is not limited thereto. The first contact portion 421 may be located forward of the second contact portion 423 in the front-rear direction.

Referring to FIGS. 3 and 4, in each of the branch portions 481 of the resilient deformation portion 14, the second inclined portion 413 is provided with the second contact portion 423. In other words, the free end portion 48 of the resilient deformation portion 14 is provided with the second contact portions 423. In the present embodiment, each of the second contact portions 423 is located between the first contact portion 421 and the mounting portion 12 in the up-down direction. Thus, in the present embodiment, the resilient deformation portion 14 is provided with the second contact portion 423 between the first contact portion 421 and the mounting portion 12 in the up-down direction. Moreover, in the present embodiment, the second contact portion 423 is located upward of and apart from the expansion portion 16 in the up-down direction.

As shown in FIG. 5, in the present embodiment, the second contact portions 423 are two in number and provided on the branch portions 481, respectively. The two second contact portions 423 are located apart from each other in the lateral direction. In the present embodiment, the second contact portions 423 are portions of side surfaces of the branch portions 481, respectively, and face inward in the lateral direction.

As shown in FIG. 6, the expansion portion 16 is provided with the third contact portion 601. In the present embodiment, the third contact portion 601 is a tip portion of the expansion portion 16. The size of the third contact portion 601 in the lateral direction is gradually reduced toward a tip of the expansion portion 16. In the present embodiment, the third contact portion 601 has two side surfaces which correspond to the two second contact portions 423, respectively, and face outward in the lateral direction.

As shown in FIGS. 1 to 7, the contact 10 of the present embodiment is further provided with a pair of deformation preventing walls 18 which extend from the mounting portion 12. In the present embodiment, the deformation preventing walls 18 extend upward from both ends of the mounting portion 12 in the lateral direction. The deformation preventing walls 18 are located at both sides of the resilient deformation portion 14 in the lateral direction and slightly apart from the resilient deformation portion 14. As shown in FIGS. 2 and 4, when viewed along the lateral direction, the deformation preventing walls 18 overlap with the resilient deformation portion 14.

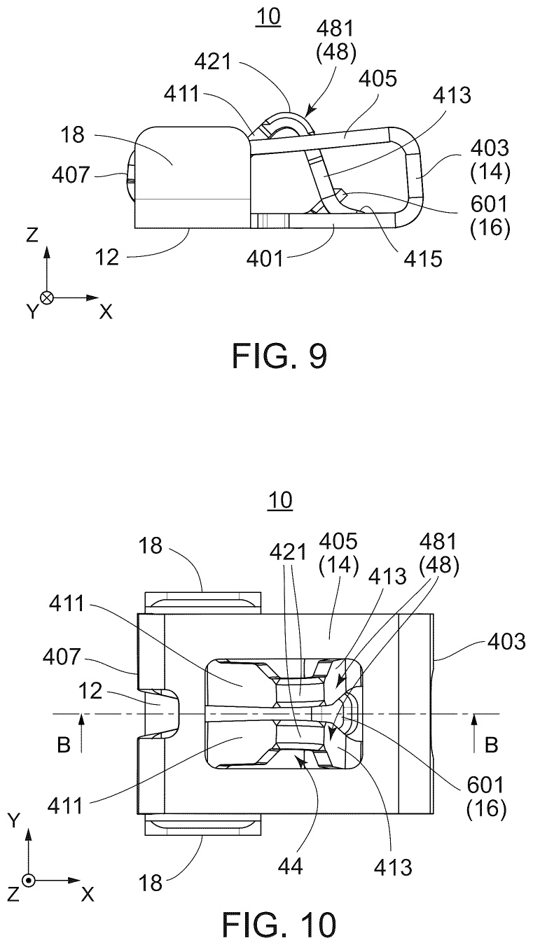

As understood from FIGS. 8 to 14, when the first contact portions 421 are pressed down, the resilient deformation portion 14 is resiliently deformed. When used, the first contact portions 421 are pressed down by being brought into contact with the second connected portion 721. Meanwhile, the deformation preventing walls 18 suppress movement of the resilient deformation portion 14 in the lateral direction.

As understood from FIGS. 10, 12 and 13, when the first contact portions 421 are brought into contact with the second connected portion 721 while the resilient deformation portion 14 is resiliently deformed, each of the second contact portions 423 and the side surface of the third contact portion 601 corresponding to the second contact portion 423 are brough into contact with each other in the lateral direction. Ideally, each of the second contact portions 423 and the side surface of the third contact portion 601 corresponding to the second contact portion 423 are brought into surface contact with each other. Actually, an edge of the second contact portion 423 may be brought into contact with the side surface of the third contact portion 601 corresponding to the second contact portion 423, or an edge of the third contact portion 601 corresponding to the second contact portion 423 may be brought into contact with the second contact portion 423. At any rate, the second contact portion 423 and the third contact portion 601 are brought into contact with each other in the lateral direction.

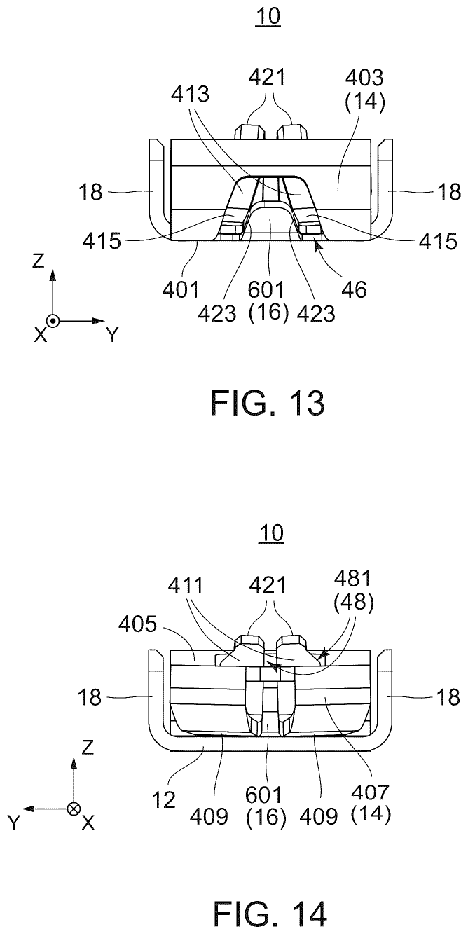

As shown in FIGS. 10, 12 and 13, in a contact state where each of the second contact portions 423 and the side surface of the third contact portion 601 corresponding to the second contact portion 423, the third contact portion 601 is located between and sandwiched by the two second contact portions 423 Meanwhile, as understood from FIGS. 10 and 13, a distance between the two branch portions 481 is increased toward tips of the branch portions 481. This is because when the second contact portions 423 are further moved downward in the up-down direction after the second contact portions 423 are brought into contact with the third contact portion 601, the distance between the second contact portions 423 is further increased by the third contact portion 601.

As shown in FIGS. 3 and 4, the fourth horizontal portion 415 is located downward of the second horizontal portion 405 in the up-down direction. As shown in FIGS. 3 and 5, when viewed along the up-down direction, the fourth horizontal portion 415 is identical with the second horizontal portion 405 at least in part. With this structure, the second horizontal portion 405 serves as a regulating portion which regulates upward movement of the fourth horizontal portion 415. Thus, the resilient deformation portion 14 has the regulating portion. In the present embodiment, the regulating portion is located upward of the second contact portions 423 in the up-down direction. Then, the regulating portion regulates the upward movement of the fourth horizontal portion 415 and thereby regulating upward movement of the second contact portions 423 beyond the regulating portion. With this structure, excessive deformation and plastic deformation of the contact 10 are prevented even when the first contact portions 421 or the second contact portions 423 are moved upward.

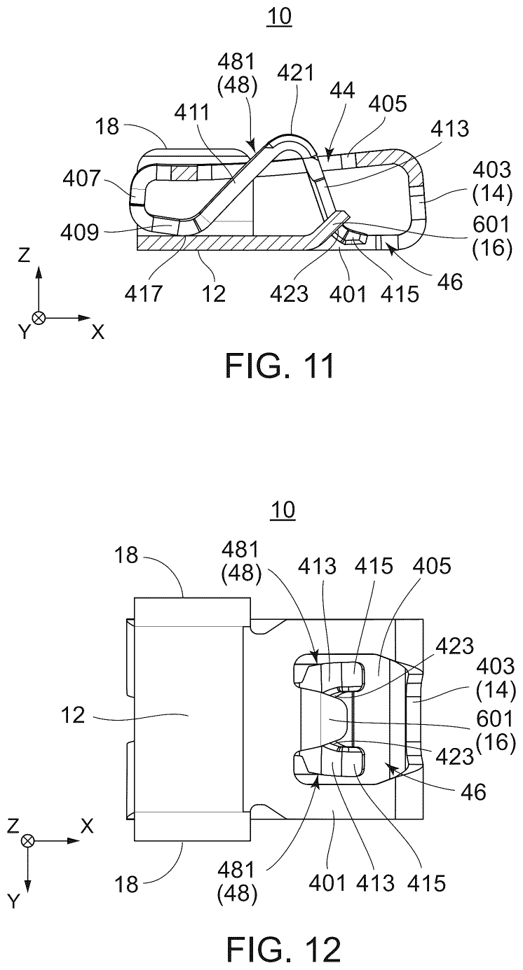

In the contact state, shown in FIG. 11, where each of the second contact portions 423 and the side surface of the third contact portion 601 corresponding to the second contact portion 423 are brought into contact with each other, a first current path is formed from the first contact portion 421 to the mounting portion 12 via the resilient deformation portion 14 in the contact 10. In addition, in the contact state, the contact 10 is also formed with a second current path from the first contact portion 421 to the mounting portion 12 via the second contact portion 423 and the third contact portion 601. As understood from FIG. 11, in the present embodiment, the length of the second current path is shorter than that of the first current path.

As understood from FIGS. 4 and 11, in the contact 10 according to the present embodiment, the third horizontal portion 409 of the resilient deformation portion 14 and the vicinity thereof serve as a spring middle portion 417 which is brought into contact with the mounting portion 12 when the second contact portions 423 are brought into contact with the third contact portion 601. In other words, in the present embodiment, the resilient deformation portion 14 further has the spring middle portion 417 which is brought into contact with the mounting portion 12 in the contact state. However, the spring middle portion 417 which is brought into contact with the mounting portion 12 is not essential in the present invention. In other words, in the present invention, the third horizontal portion 409 and the vicinity thereof may not be brought into contact with the mounting portion 12 when the second contact portions 423 are brought into contact with the third contact portion 601.

As shown in FIG. 11, in the present embodiment, the spring middle portion 417 is provided so that the first contact portion 421 is located between the spring middle portion 417 and the second contact portion 423 in the front-rear direction. Contacting between the spring middle portion 417 and the mounting portion 12 further forms a third current path from the first contact portion 421 to the mounting portion 12 via the spring middle portion 417 in the contact state. In the present embodiment, the third current path is shorter than the second current path.

As described above, the contact 10 of the present embodiment is provided with the resilient deformation portion 14 which has a relatively long cantilever shape and thereby good spring characteristics can be achieved. Moreover, contacting between the second contact portion 423 and the third contact portion 601 is achieved in the lateral direction, and thereby deterioration of the spring characteristics of the resilient deformation portion 14 can be suppressed when the resilient deformation portion 14 is resiliently deformed. In addition, the contact 10 is provided with the second contact portion 423 and the third contact portion 601, and thereby the current path from the first contact portion 421 to the mounting portion 12 can be shortened. Furthermore, the contact 10 allows the spring middle portion 417 to be brought into contact with the mounting portion 12, and thereby the third current path is shorter than the second current path can be achieved.

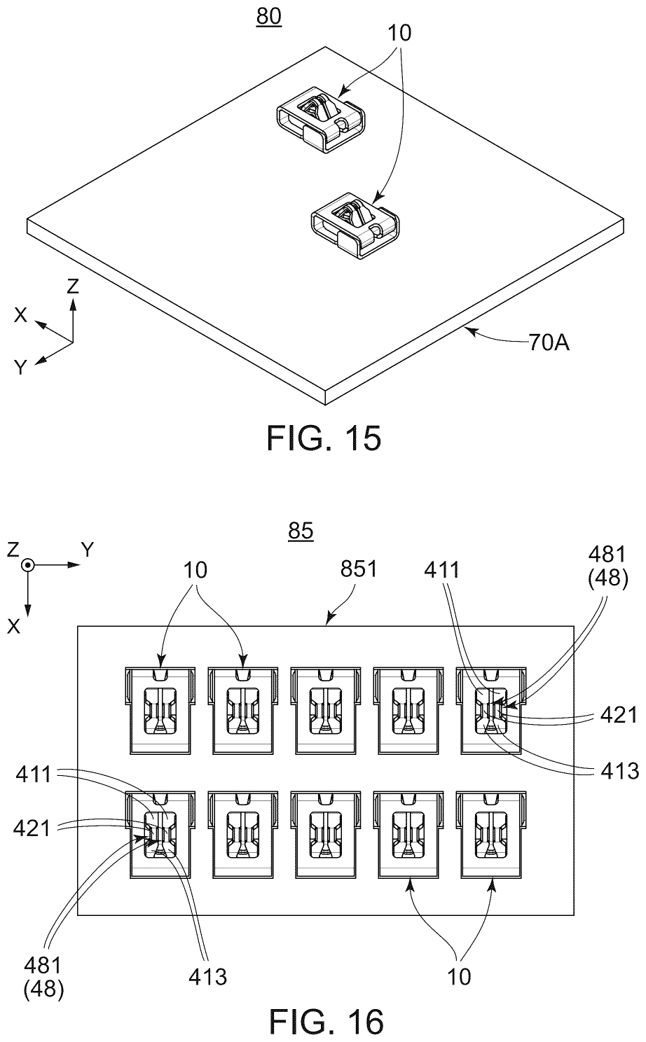

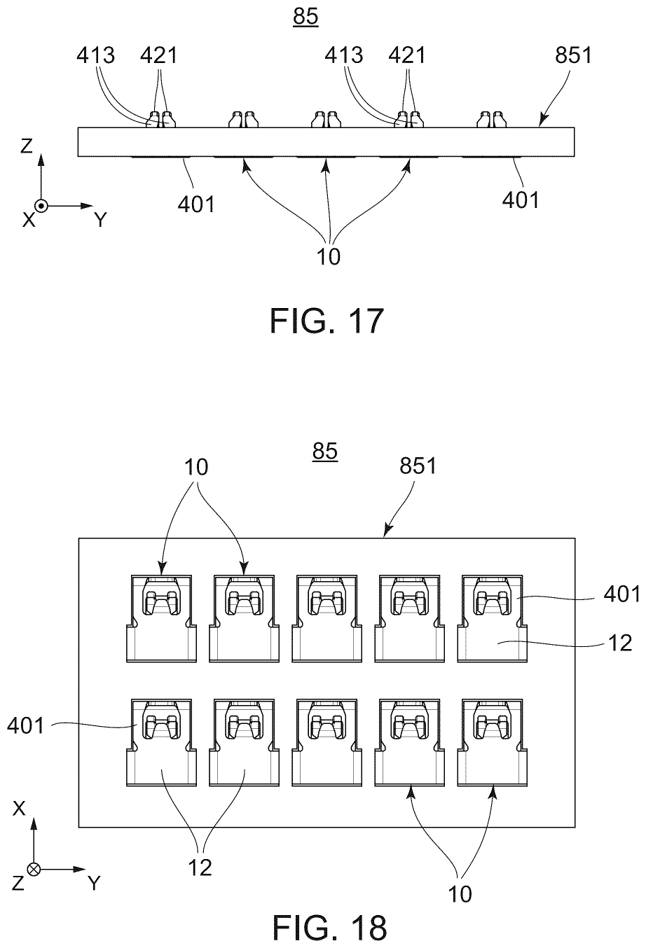

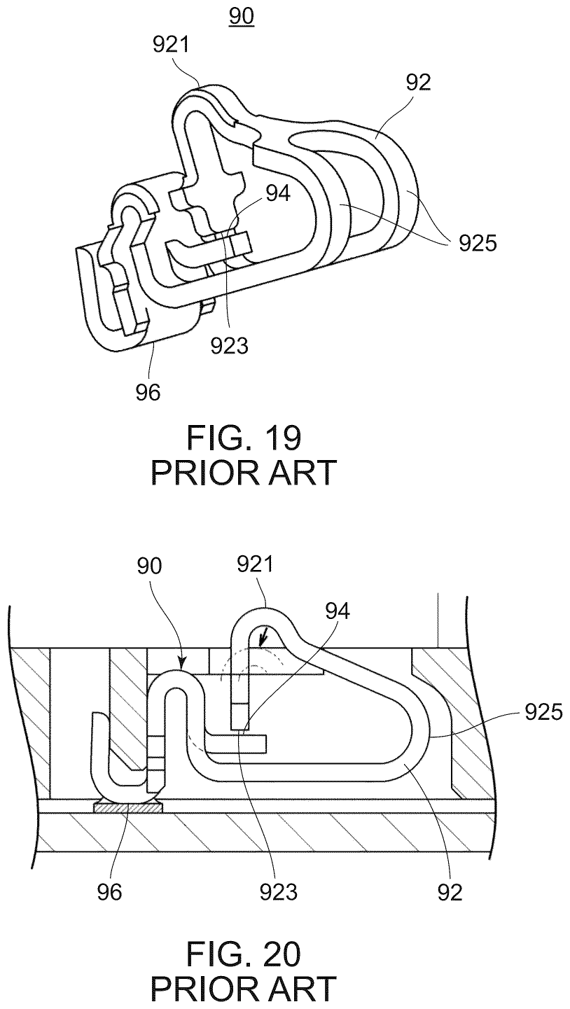

As shown in FIG. 15, the contacts 10 according to the present embodiment can be used to form a contact mounting board 80. As shown in FIGS. 16 to 18, the contacts 10 are also used to form a connector 85.

The contact mounting board 80 shown in FIG. 15 is provided with the contacts 10 and a board 70A. In the contact mounting board 80, the number of the contacts 10 is two. However, the present invention is not limited thereto. In the present invention, the contact mounting board 80 may be provided with three or more contacts 10. At any rate, the contacts 10 are arranged in two dimensions on the board 70A.

The connector 85 shown in FIGS. 16 to 18 is provided with the contacts 10 and a holding member 851. In the connector 85, the contacts 10 are ten in number and arranged in two rows. However, the present invention is not limited thereto. In the present invention, the connector 85 should have one or more contacts 10 and the holding member 851 holding the contacts 10. Moreover, in the present invention, the contacts 10 included in the connector 85 may be arranged in one, three or more rows.

As understood from FIGS. 16 to 18, in the connector 85, the first contact portions 421 of each of the contacts 10 are located upward of an upper surface of the holding member 851 in the up-down direction. This is to allow the first contact portions 421 to be brought into contact with the second connected portion 721 (see FIG. 2). Moreover, in the connector 85, the mounting portion 12 of each of the contacts 10 is located downward of a lower surface of the holding member 851 in the up-down direction. This is to allow the mounting portion 12 to be connected to the first connected portion 701 (see FIG. 2).

Although the specific explanation about the present invention is made above with reference to concrete embodiments, the present invention is not limited thereto but susceptible of various modifications and alternative forms without departing from the spirit of the invention. For example, the shape of the resilient deformation portion 14 is not limited to that of the aforementioned embodiment but may be any shape. In addition, provided that the second current path which passes through the second contact portion 423 is shorter than the first current path which depends on the length of the resilient deformation portion 14, the first contact portion 421 and the second contact portion 423 may be provided anywhere on the resilient deformation portion 14 in any way. In one example, a branch portion branched from a midpoint of the first inclined portion 411 may be provided in place of the second inclined portion 413, and the second contact portion 423 may be provided on the branched portion. For another example, a bent portion which is bent rearward after it extends from a front end of the first inclined portion 411 may be provided in place of the second inclined portion 413, and the second contact portion 423 may be provided on the bent portion.

In the aforementioned embodiment, the second contact portion 423 is located forward of the first contact portion 421 in the front-rear direction. However, in the present invention, the second contact portion 423 may be located rearward of the first contact portion 421 in the front-rear direction. To achieve this, the branch portion mentioned above or the bent portion mentioned above may be used. Nevertheless, the structure in which the second contact portion 423 is located forward of the first contact portion 421 makes it easy to prevent the excess deformation of the resilient deformation portion 14 caused by the regulating portion.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A contact which electrically connects a first connected portion of a first board located downward of the contact in an up-down direction to a second connected portion of a second board located upward of the contact in the up-down direction, wherein:
the contact has a mounting portion connected to the first connected portion, a resilient deformation portion extending from the mounting portion and having a cantilever shape and an expansion portion extending from the mounting portion;
the resilient deformation portion is provided with a first contact portion to be brough into contact with the second connected portion and a second contact portion located between the first contact portion and the mounting portion in the up-down direction;
the expansion portion is provided with a third contact portion;
when the first contact portion is brought into contact with the second connected portion while the resilient deformation portion is resiliently deformed, the second contact portion and the third contact portion are brought into contact with each other in a lateral direction perpendicular to the up-down direction; and
in a contact state where the second contact portion and the third contact portion are bought into contact with each other, a length of a second current path from the first contact portion to the mounting portion via the second contact portion and the third contact portion is shorter than a length of a first current path from the first contact portion to the mounting portion via the resilient deformation portion.

2. The contact as recited in claim 1, wherein the second contact portion is provided on a free end portion of the resilient deformation portion.

3. The contact as recited in claim 2, wherein in a front-rear direction perpendicular to both the up-down direction and the lateral direction, the first contact portion is located between the mounting portion and the second contact portion.

4. The contact as recited in claim 3, wherein:
the resilient deformation portion further has a regulating portion; and
the regulating portion is located upward of the second contact portion in the up-down direction and regulates upward movement of the second contact portion beyond the regulating portion.

5. The contact as recited in claim 2, wherein:
the free end portion of the resilient deformation portion is branched into two branch portions;
the second contact portion comprises two second contact portions; the second contact portions are provided on the branch portions, respectively;
the two second contact portions are located apart from each other in the lateral direction; and
in the contact state, the third contact portion is sandwiched between the two second contact portions.

6. The contact as recited in claim 5, wherein:
the third contact portion has a size, in the lateral direction, gradually reduced toward a tip thereof; and
in the contact state, a distance between the two branch portions is increased toward tips of them.

7. The contact as recited in claim 1, wherein:
the resilient deformation portion further has a spring middle portion;
the first contact portion is located between the spring middle portion and the second contact portion; and
in the contact state, the spring middle portion is brought into contact with the mounting portion and further forms a third current path from the first contact portion to the mounting portion via the spring middle portion.

8. The contact as recited in claim 1, wherein:
the contact is further provided with a pair of deformation preventing walls extended form the mounting portion;
the deformation preventing walls are located at both sides of the resilient deformation portion in the lateral direction; and
when viewed along the lateral direction, the deformation preventing walls overlap with the resilient deformation portion.

9. A connector comprising the contact as recited claim 1 and a holding member holding the contact.

10. A contact mounting board comprising a plurality of the contacts as recited in claim 1 and a board, wherein the contacts are arranged on the board.
